(19) United States
(12) Patent Application Publication
(10) Pub. No.: US 2023/0123982 A1
(43) Pub. Date: Apr. 20, 2023

(54) HEAT PUMP SYSTEM AND COOLING/HEATING SYSTEM USING SAME

(71) Applicant: WORLD ONE HI-TECH, INC., Eumseong-gun (KR)

(72) Inventor: Yong Heung LEE, Gwangju-si (KR)

(21) Appl. No.: 17/910,126

(22) PCT Filed: Mar. 19, 2021
(86) PCT No.: PCT/KR2021/003412

§ 371 Date: Sep. 8, 2022

(30) Foreign Application Priority Data
Mar. 20, 2020 (KR) 10-2020-0034611

(51) Int. Cl. F25B 30/00; F25B 41/40; F28D 20/00

(52) U.S. Cl. CPC F25B 30/00; F25B 41/40; F28D 20/00; F28D 2020/0078; F28D 2020/0069

(57) ABSTRACT

A heat pump system and a cooling/heating system using same, the heat pump system being able to prevent the occurrence of a vortex in a process in which fluid flows into a heat storage tank, and to supply and maintain constant-temperature cooling and heating. The heat pump system according to the present invention includes: an indoor unit which functions as a condenser during heating and functions as an evaporator during cooling; an outdoor unit which functions as an evaporator during heating and functions as a condenser during cooling; a heating medium for heat exchange; and a heat storage tank in which the heating medium for cold/hot water is stored.

### TECHNICAL FIELD

The present invention relates to a heat pump system, and more particularly, to a heat pump system in which an indoor unit and an outdoor unit are converted into a condenser and an evaporator according to selection of heating and cooling, and a heating and cooling system using the same.

### BACKGROUND OF INVENTION

A typical heat pump system repeats the cycle in which the refrigerant flows back into a compressor via the condenser, an expansion valve, and an evaporator. The refrigerant passing through the compressor is converted into a liquid phase in the condenser, which is a heat exchanger, and is configured to release latent heat, absorb external heat in the evaporator, and evaporate to provide cooling/heating.

Conventional heating/cooling systems using heat pumps may not be able to handle user loads depending on the temperature section, and in particular, it is difficult to maintain an appropriate heating/cooling temperature at a constant temperature. Therefore, it is necessary to design a heat pump heating/cooling system that can be operated stably while always maintaining a constant temperature in various user load environments.

In general, the heat pump system enables fast and uniform heating of saturated steam according to latent heating, the relationship between pressure and temperature can be accurately set, and the advantage of high thermal conductivity. has the problem of lowering. Therefore, to utilize the latent heat of the saturated steam of the heat pump system for cooling/heating, control conditions such as temperature and pressure on the load side should be optimized.

To this, a heat pump system disclosed in Korean Utility Model No. 20-281266 may include a liquid receiver installed between a condenser and an expansion valve to supply only liquid refrigerant to the expansion valve; an ejector to increase the refrigerant circulation amount by increasing the pressure of the refrigerant vapor evaporated in the evaporator; a superheat control device for controlling the superheat degree of the refrigerant at the inlet of the compressor; a capacity control device for adjusting the capacity by controlling the refrigerant flow rate; and a multi-stage condensing pressure control valve for controlling the condensing pressure in multiple stages.

However, the heat pump system, such as Korea Utility Model No. 20-281266, has problems in that a number of additional devices must be additionally installed, which significantly increases the cost of constructing the heat pump system and requires more cost for maintenance.

Furthermore, the superheat control device of the heat pump system of Korea Utility Model No. 20-281266 has a disadvantage in that an additional heat exchanger is required for heat exchange between the refrigerant passing through the condenser and the refrigerant vapor at the inlet of the compressor.

On the other hand, the plate heat exchanger is a device in which different types of heating medium flow alternately in each layer and heat exchange is performed.

For reference, the heating medium is made of a liquid fluid, preferably antifreeze, water, or pure water.

The plate heat exchanger is easy to assemble, has a small number of parts, so productivity is good, and the volume can be reduced, which is advantageous in securing space. In particular, the plate heat exchanger can design a complicated and diversified flow path by changing the shape of the plate. In particular, when two types of heat medium flow and heat exchange with each other, it is better to apply a plate heat exchanger.

When such a plate heat exchanger is applied to a heat pump system, the distribution of fluid (i.e., heat medium) flow must be made uniformly over the entire area, and for this, designing of pipe inner diameter and flow rate is important.

Meanwhile, in the heat pump system, the heat medium for heat exchange flows into and out of the heat storage tank. However, a vortex, swirling, may be generated inside the heat storage tank due to the high flow velocity of the heat medium while the heat medium, which is a fluid, is introduced into the heat storage tank.

When such a vortex occurs, a swirling flow is generated in the opposite direction to the mainstream due to the rotational motion of the heating medium, impeding the continuous and uniform supply of the heating medium, as a result, it may eventually become difficult to optimally heat exchange, supply cooling/heating at a constant temperature, and operate the system in a stable manner.

### DETAILED DESCRIPTION OF THE INVENTION

### Technical Problems to be Solved

The present invention is to solve the above problems, and an object of the present invention is to provide a heat pump system capable of preventing a vortex generated while a fluid is introduced into a heat storage tank and a cooling/heating system using the same.

Another object of the present invention is providing a heat pump system capable of realizing heat exchange of 13 to 18° C. during heating and 3 to 7° C. during cooling with optimum efficiency, and capable of supplying and always maintaining cooling/heating at constant temperature, and proving a cooling/heating system using the system without installing various additional devices, including overheating regulators, multi-stage condensation pressure control sides, etc.

### Means for Solving Problems

According to an aspect of the present invention, a heat pump system is provided, which includes: an indoor unit functioning as a condenser during heating and an evaporator during cooling; an outdoor unit that functions as an evaporator for heating and a condenser for cooling; a heating medium heat-exchanged while passing through the indoor unit; and a heat storage tank into which a heating medium that has become cold water or hot water while passing through the indoor unit is introduced;

a first water inlet pipe for guiding the heating medium returning after passing through the indoor unit to flow into the heat storage tank; a first water outlet pipe for guiding the thermal medium introduced into the heat storage tank through the first inlet pipe to output to a load outside the heat storage tank; a second inlet pipe for guiding the heat medium returning to the load side outside the heat storage tank through the first water outlet pipe to flow into the heat storage tank; and a second water outlet pipe for guiding the heating medium introduced into the heat storage tank through the second water inlet pipe to flow out toward the indoor unit.

The first water inlet pipe may include a first inlet formed in a structure introduced into the heat storage tank and a plurality of through-holes formed through a portion of the first inlet portion facing an upper direction of the heat storage tank.

The first water outlet pipe includes a first inlet formed in communication with the inside of the heat storage tank so that the heat medium in the heat storage tank can be introduced into the inside of the first water outlet pipe.

The first inlet is formed to be in an area higher than an area in which the first inlet is in the heat storage tank.

The second water inlet pipe may include a second inlet part formed by a structure drawn into the heat storage tank; and a plurality of through holes formed through the second inlet part that are formed through the area facing the lower direction of the heat storage tank.

The second water outlet pipe may include a second inlet that is formed in communication with the inside of the heat storage tank so that the heat medium in the heat storage tank can be introduced into the second water outlet pipe.

The second inlet is formed to be in an area lower than an area in which the second inlet part is in the heat storage tank.

According to the heat pump system and the cooling/heating system using the same according to the present invention, it is possible to effectively disperse and diffuse the water pressure of the fluid flowing into the heat storage tank to prevent vortex generation and to minimize heat loss. Accordingly, it is possible to ensure the continuous and uniform supply of the heating medium, to allow the heat to be efficiently transferred and exchanged, and to provide the cooling/heating supply at a constant temperature and to promote the stable operation of the system.

According to the heat pump system and the cooling/heating system using the same according to the present invention, it is possible to maintain an appropriate cooling/heating temperature of a constant temperature in various user load environments, thereby stably operating the heat pump system.

In particular, without the need to install additional devices such as overheating control devices, heat exchange of 13 to 18° C. in heating and 3 to 7° C. in cooling can be implemented with optimal efficiency, and the cost of building and maintaining a heat pump system can be greatly reduced.

### BRIEF DESCRIPTIONS OF THE DRAWINGS

FIG. 1 is a block diagram of a heat pump system according to the first embodiment of the present invention.

FIG. 2 is a perspective view of the first heat exchanger according to an embodiment of the present invention.

FIG. 3 is a disassembly perspective view of FIG. 2.

FIG. 4 is a perspective view of the second heat exchanger according to an embodiment of the present invention.

FIG. 5 is an exploded perspective view of FIG. 4.

FIG. 6 is a cross section of the heat storage tank according to the invention and the vortex preventing apparatus installed therein.

FIG. 7 is a cross section of the first inlet part of the first water inlet pipe according to the present invention.

FIG. 8 is a cross section of the second inlet part of the second water inlet pipe according to the present invention.

FIG. 9 is a block diagram of the heat pump system according to the second embodiment of the present invention.

FIG. 10 is a block diagram of the heat pump system according to the third embodiment of the present invention.

FIG. 11 is a block diagram of the heat pump system according to the 4th embodiment of the present invention.

FIG. 12 is a block diagram of the heat pump system according to an extended embodiment of the present invention.

FIG. 13 is a diagram showing the fluid flow in the heating operation of the heat pump system according to the present invention and the heat exchange operation thereof.

FIG. 14 is a diagram showing the fluid flow in the cooling operation of the heat pump system according to the present invention and the heat exchange operation thereof.

FIG. 15 is a block diagram of a cooling/heating system using the heat pump system of the present invention.

### DESCRIPTION OF REFERENCE NUMERIC

10: indoor unit 20: outdoor unit
30: compressor 40: four-way valve
50: expansion valve 60: Liquid heater
65: sensor 70: auxiliary tank
81: heating medium line 90: heat storage tank
91: first fluid line 93: second fluid line
100: first heat exchanger 110, 210: heat plate
140: first channel 150: second channel
200: second heat exchanger 240: third channel
250: fourth channel 310: hot/cold Water Supply Header
320: cold/hot water return header 330: Differential pressure valve
340: user device 400: first water inlet pipe
410: first inlet part 411: through hole of first inlet part
413: first inlet part opening 420: first water outlet pipe
423: first inlet 430: second water inlet pipe
440: second inlet part 441: through hole of second inlet part
443: opening of second inlet part 450: second water outlet pipe
453: second inlet 460: vortex preventing plate

### EMBODIMENTS OF THE INVENTION

The terms used herein are used only to describe a particular embodiment and are not intended to limit the present invention. Expressions in the singular include plural expressions unless the context explicitly means otherwise. Herein, the term “comprises” or “has”, and the like is intended to designate the presence of a feature, number, step, operation, component, part, or a combination thereof described above, and does not preclude the presence or possibility of addition of one or more other features or numbers, steps, operations, components, parts, or combinations thereof.

In addition, as used herein, “on or on the top of” means that it is located above or below the subject portion, which does not necessarily mean that it is located upwards with respect to the direction of gravity. That is, the term “on or above the ˜top” referred to herein includes not only the case of being located above or below the subject part, but also the case of being located before or behind the target portion.

In addition, when a part of a region, plate, etc. is said to be “on or on top” of another part, it includes not only the case that the other part is in contact with or spaced “directly on or on the top”, but also when there is another part in between.

In addition, herein, when one component is referred to as “connected” or “connected” to another component, etc., it should be understood that the one component may be directly connected or directly connected to the other component but may be connected or connected by mediating another component in the middle, unless there is a particularly opposite description.

In addition, herein, the terms 1st, 2nd, etc. may be used to describe various components, but the components should not be limited by the terms. The terms are used only for the purpose of distinguishing one component from another.

Hereinafter, the following drawings will be used to describe in detail the preferred embodiments, advantages and features of the present invention.

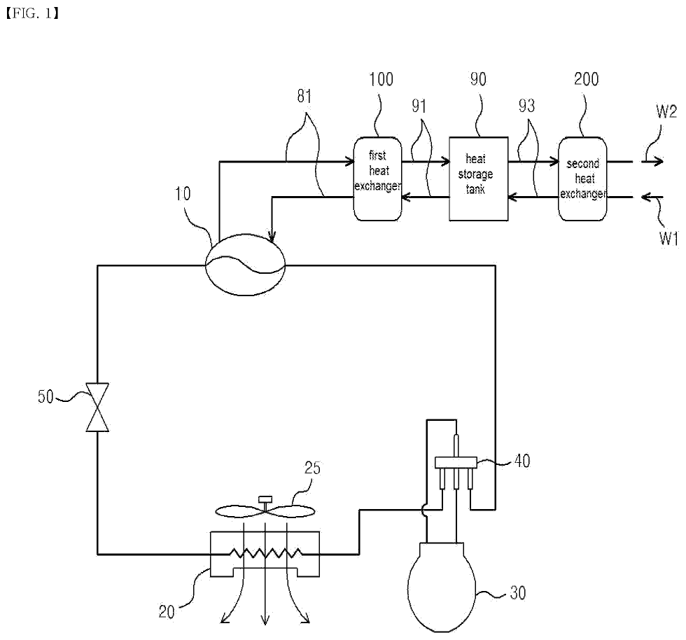

FIG. 1 is a block diagram of a heat pump system according to the first embodiment of the present invention. Referring to FIG. 1, a heat pump system according to the present invention may include an indoor unit 10, an outdoor unit 20, a compressor 30, an expansion valve 50, a four-way valve 40, a heat medium, a first heat exchanger 100, a heat storage tank 90, and a second heat exchanger 200.

The indoor unit 10 is configured to switch to a condenser or evaporator upon selection of a cooling/heating mode. Specifically, the indoor unit 10 is configured to function as a condenser in heating, i.e., in a heating mode and as an evaporator when cooling, i.e., in a coiling mode.

The outdoor unit 20 may be configured to switch to an evaporator or a condenser upon selection of a cooling mode or a heating mode, respectively. Specifically, the outdoor unit 20 is configured to function as an evaporator during heating and as a condenser during cooling. On the other hand, a fan 25 is installed on the outdoor unit 20 and may be configured to blow to the outdoor unit 20.

The compressor 30 may be configured to compress the refrigerant delivered from the evaporator. Specifically, the compressor 30 may compress the dry saturated refrigerant delivered from the evaporator and converts it into a superheated steam state.

The condenser is configured to condense the refrigerant delivered from the compressor 30 by phase conversion into a liquid phase.

The expansion valve 50 is configured to inflate the refrigerant that has coarse the condenser. The refrigerant that has undergone such an expansion valve 50 is converted to a wet vapor state and then introduced into the evaporator.

The evaporator is configured to evaporate the refrigerant via the expansion valve 50 and convert it to a dry saturated steam state.

The four-way valve 40 may be configured to switch the refrigerant flow according to heating and cooling. Specifically, the four-way valve 40 is installed in the middle of the refrigerant fluid between the indoor unit 10 and the outdoor unit 20 to change the path through which the refrigerant flows, thereby allowing the indoor unit 10 and the outdoor unit 20 to switch to a condenser or evaporator.

The heat medium may circulate the indoor unit 10 and the first heat exchanger 100 through the heating medium line 81 and may be configured for heat exchange.

The heat medium is made of a liquid fluid, and may preferably be made of antifreeze, water, or pure water.

The heating medium line 81 may be constructed in the form of a closed circuit via the indoor unit 10 and then again via the first heat exchanger 100 and may be filled with a heat medium inside.

For example, in FIG. 1, ‘W1’ means a second fluid that is used for heat exchange at a load (i.e., a user device) and then introduced back into, i.e., returned, the second heat exchanger 200, and ‘W2’ means a second fluid that is heat exchanged with the first fluid in the second heat exchanger 200 and flows to the hot and cold water supply header 310 to be described below. That is, the second fluid refers to the fluid flowing back into the second heat exchanger after the first fluid flows out of the ‘second heat exchanger’ to the load (user device) side. For reference, the second fluid line is named ‘second’ for the purpose of distinguishing it from the first fluid line.

It does not mean the line through which the second fluid flows.

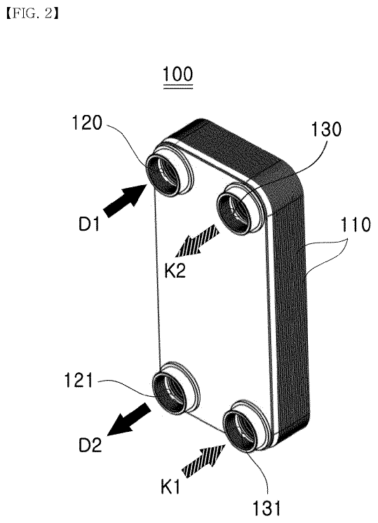

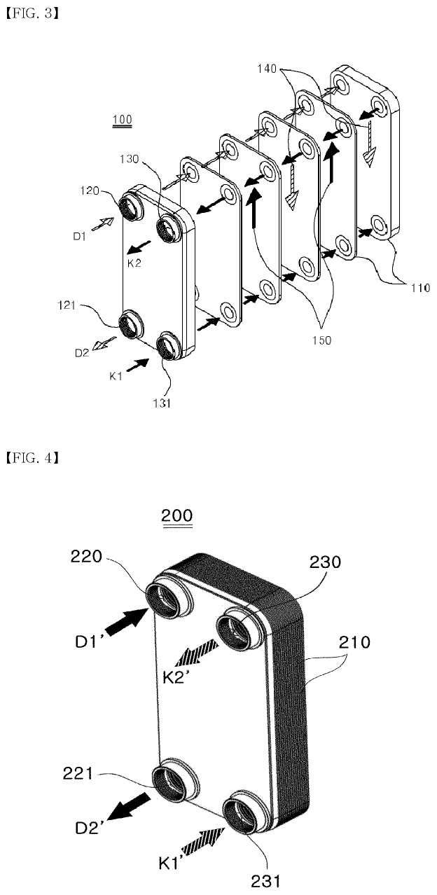

FIG. 2 is a perspective view of the first heat exchanger according to an embodiment of the present invention. FIG. 3 is a disassembly perspective view of FIG. 2. Based on the first embodiment described in FIG. 1, the first heat exchanger of the present invention is described as follows.

The first heat exchanger 100 is a device for heat exchange between heat energy or cold energy generated by the indoor unit 10 and a fluid of the heat storage tank 90.

The first heat exchanger 100 is coupled to the indoor unit 10 via the heating medium line 81 and to the heat storage tank 90 via a fluid line (hereinafter referred to as the ‘first fluid line 91’).

Inside the first fluid line 91 is a flow diagram of fluid (hereinafter referred to as the ‘first fluid’) that flows out of the heat storage tank 90 and is recovered to the heat storage tank 90 after passing through the first heat exchanger 100. Here, the first fluid may be water supplied from the water source.

The heating medium line 81 forms a closed circuit via the indoor unit 10 and the first heat exchanger 100, and the first fluid line 91 forms a closed circuit via the first heat exchanger 100 and the heat storage tank 90.

Thus, the heat medium exchanged through the indoor unit 10 is heat exchanged with the first fluid through the first heat exchanger 100.

The first heat exchanger 100 is composed of different temperature fluids (i.e., heat mediums, first fluids) flowing between the heat plates in opposite directions and heat exchange between the hot fluids and the low temperature fluids is carried out.

Preferably, the first heat exchanger may consist of a plate heat exchanger. In this case, the first heat exchanger 100 includes the first channel 140, the second channel 150, the plurality of heat plates 110, the first pipe, and the second pipe.

The first channel 140 is formed between a pair of heat plates as the flow path through which the thermal medium passes, and the second channel 150 is formed between another pair of heat plates as the flow path through which the first fluid passes.

The heat plate 110 forms a stacking structure in which a plurality of heat plates is arranged at predetermined intervals. The heat plate 110 can be formed of a stainless-steel material, and a space in which the fluid flows is formed so that heat can be transferred efficiently.

The flow path through which the thermal medium passes (i.e., the first channel 140) and the flow path through which the first fluid passes (i.e., the second channel 150) are constructed in alternating configurations along the lamination direction of the heat plate 110.

The first pipe is a pipe connected to the first channel 140 to guide the thermal medium inflow D1 and outflow D2 of the first channel 140.

Specifically, the first pipe includes an 1a pipe coupled to an inlet 120 for inputting the thermal medium into the first channel 140 and an 1b pipe coupled to an outlet 121 for recovering the thermal medium, which passes through the first channel 140 from the first channel 140.

The second pipe is a pipe connected to the second channel 150 to guide the first fluid from a K1 direction, inflow to a K2 direction, outflow of the second channel 150.

Specifically, the second pipe includes a 2a pipe that is connected to an inlet 131 for injecting the first fluid into the second channel 150, and a 2b pipe that is connected to an outlet 130 for recovering the first fluid, which passes through the second channel 150 from the second channel 150.

The heat storage tank 90 is a water tank that stores axial cooling or thermal energy generated by the indoor unit 10 and is configured to store the heat source during heating and store the cold source during cooling, so as to provide selectively cooling or heating according to a season of operating. Preferably, a vortex prevention device may be installed in the heat storage tank 90.

A first fluid is stored in the heat storage tank 90, the first fluid is heat exchanged with the thermal medium by via a first heat exchanger 100 through the first fluid line 91, and heat exchange is made with the second fluid by passing the second heat exchanger 200 via the second fluid line 93.

Here, the first fluid stored in the heat storage tank 90 may be water supplied from the water source.

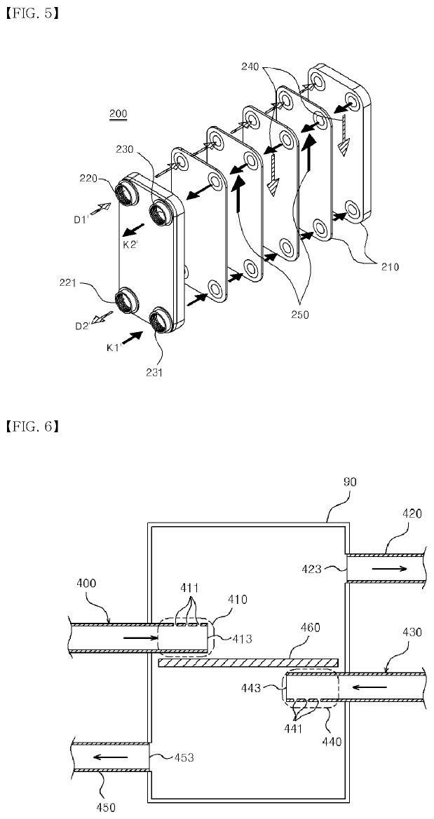

FIG. 4 is a perspective view of the second heat exchanger according to an embodiment of the present invention, FIG. 5 is an exploded perspective view of FIG. 4.

Based on the first embodiment of FIG. 1, the second heat exchanger of the present invention is described as follows.

The second heat exchanger 200 is composed of fluids of different degrees of temperature flowing between the heat plates 110 in opposite directions from each other, so that heat exchange between the hot fluid and the low temperature fluid takes place.

Preferably, the second heat exchanger may consist of a plate heat exchanger, in which case the second heat exchanger 200 includes a third channel 240, a fourth channel 250, a plurality of heat plates 210, a third pipe, and a fourth pipe.

The third channel 240 is formed between the heat plates as the flow path through which the first fluid (thermal medium in the case of the 3rd and 4th embodiments) passes, and the fourth channel 250 is formed between the other heat plates as a flow path through which the second fluid passes.

The heat plate 210 forms a stacking structure in which a plurality of heat plate is arranged at a predetermined interval. The heat plate 210 can be formed of a stainless-steel material, and a space in which the fluid flows is formed so that heat can be transferred efficiently.

The flow path through which the first fluid (in the case of the thermal medium in the case of the 3rd and 4th embodiments) passes through (i.e., the third channel 240) and the flow path through which the second fluid passes (i.e., the fourth channel 250) are provided alternately along the lamination direction of the heat plate 210.

The third pipe is a tube connected to the third channel 240 to guide the third channel 240 inflow (D1′)/outflow (D2′) of the first fluid (thermal medium in the case of the 3rd and 4th embodiments).

Specifically, the third pipe includes a 3a pipe connected to the inlet 220 for injecting a first fluid (thermal medium in the case of the 3rd and 4th embodiment) into the third channel 240, and a 3b pipe connected to an outlet 221 for returning the first fluid, which passes through the third channel 240.

The fourth pipe is a pipe connected to the fourth channel 250 to guide the fourth channel 250 inlet (K1′)/outflow (K2′) of the second fluid.

Specifically, the fourth pipe includes a 4a pipe coupled to an inlet 231 for injecting a second fluid into the fourth channel 250 and a 4b pipe coupled to an outlet 230 for recovering a second fluid that has passed through the fourth channel 250.

Below, based on the first embodiment described in FIG. 1, the vortex preventing apparatus of the present invention will be described in detail.

The first fluid flows back into the heat storage tank 90 after via the first heat exchanger or the second heat exchanger, where a vortex may be generated inside the heat storage tank 90 due to the rapid flow rate of the first fluid.

When such a vortex occurs, a swirling flow is generated in the opposite direction from the mainstream by the rotational motion of the first fluid, which hinders the continuous and uniform supply of the first fluid and reduces the thermal efficiency, which in turn causes problems that make it difficult to achieve optimal heat exchange performance, cooling/heating supply at constant temperature, and stable operation of the system.

The vortex preventing apparatus of the present invention thus serves to prevent vortex flows that may occur in the process of entering the first fluid into the heat storage tank 90.

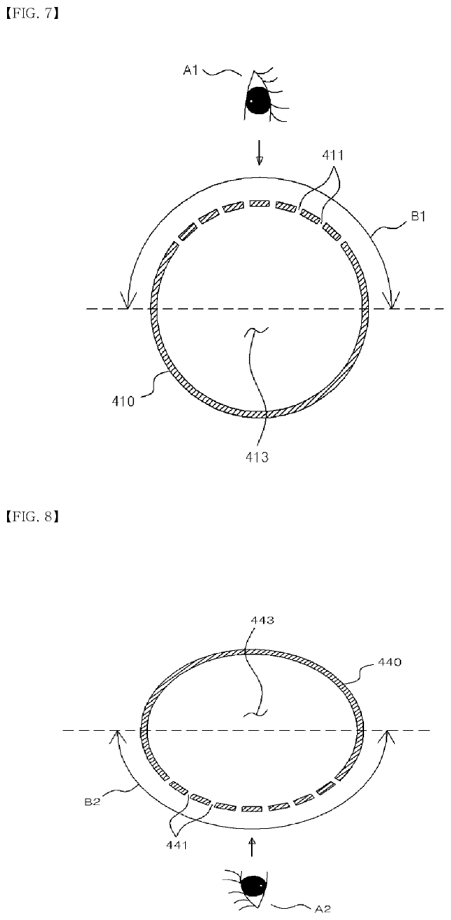

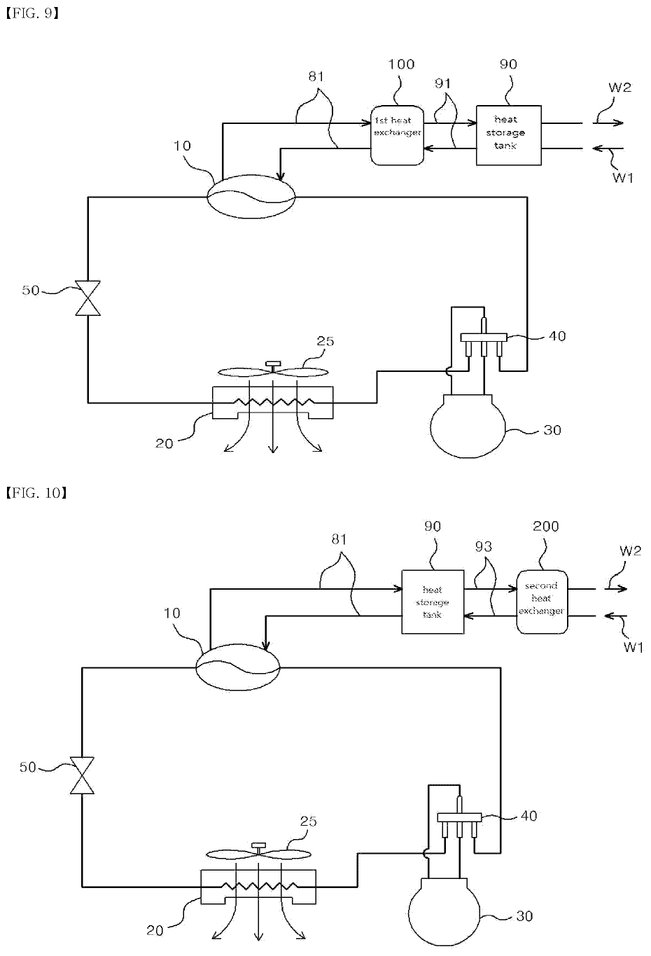

FIG. 6 is a cross section of the heat tank according to the invention and the vortex preventing apparatus installed therein, FIG. 7 is a cross section of the first inlet part of the first water inlet pipe according to the present invention, FIG. 8 is a cross section of the second inlet part of the second water inlet pipe according to the present invention.

Referring to FIG. 6 to FIG. 8, the vortex preventing apparatus of the present invention may include a first water inlet pipe 400, a first water outlet pipe 420, a second water inlet pipe 430, a second water outlet pipe 450, and a vortex preventing plate 460.

The first water inlet pipe 400 may be a configuration that guides the first fluid returning after passing through the first heat exchanger to enter the heat storage tank 90. The first water inlet pipe 400 may be configured as a pipe connected to the inside of the heat storage tank 90.

The first water inlet pipe 400 includes a first inlet part 410 formed by a structure drawn into the heat storage tank 90 and a plurality of through holes 411 formed through the area of the first inlet part 410 facing the upward direction of the heat storage tank 90.

Here, the term “region facing the upward direction of the heat storage tank 90” of the first inlet part 410 refers to the area visible when looking at the first inlet part 410 at the vertical top of the first inlet part 410.

Thus, assuming that the first inlet part 410 is a tube of a circular cross-section, as in the example of FIG. 7, the region ‘B1’ corresponds to the region B1 that is visible when looking at the first inlet part 410 at the vertical top of the first inlet part 410, i.e., the region B1 facing the upward direction of the heat storage tank 90.

On the other hand, one end of the first inlet part 410 may be openly formed in the form of a hole 413. In this case, a portion of the first fluid traveling inside the first water inlet pipe 400 is discharged through the hole. That is, the second fluid refers to the fluid flowing back into the second heat exchanger after the first fluid flows out of the ‘second heat exchanger’ to the load (user device) side.

For reference, the second fluid line is named ‘second’ for the purpose of distinguishing it from the first fluid line.

It does not mean the line through which the second fluid flows. h411 in the upward direction of the first inlet part 410 and enters the heat storage tank 90, and the remainder is discharged through the hole 413 in the right direction of the first inlet part 410 (relative to FIG. 3) and into the heat storage tank 90.

The first water outlet pipe 420 is a configuration that guides the first fluid introduced into the heat storage tank 90 through the first water inlet pipe 400 to the second heat exchanger side. The first water outlet pipe 420 may be configured as a pipe connected to the inside of the heat storage tank 90.

The first water outlet pipe 420 includes a first inlet 423 that is formed in communication with the inside of the heat storage tank 90 so that the first fluid stored in the heat storage tank 90 can be introduced into the first water outlet pipe 420.

The first inlet 423 is formed to be in an area higher than the area in which the first inlet part 410 of the first water inlet pipe 400 is located in the heat storage tank 90.

The second water inlet pipe 430 is a configuration that guides the first fluid returning after passing through the second heat exchanger to enter the heat storage tank 90. The first water inlet pipe 400 may be configured as a pipe connected to the inside of the heat storage tank 90.

The second water inlet pipe 430 includes a second inlet part 440 formed by a structure drawn into the heat storage tank 90 and a plurality of through holes 441 formed through the second inlet portion 440 that are formed through the area facing the lower direction of the heat storage tank 90.

Here, the term “area facing the downward direction of the heat storage tank 90” of the second inlet part 440 refers to the area visible when looking at the second inlet part 440 at the vertical bottom of the second inlet part 440.

Thus, if the second inlet part 440 is a tube of a circular cross-section, as in the example of FIG. 8, the region ‘B2’ is visible when looking at the second inlet part 440 at the vertical bottom of the second inlet part 440 (A2). That is, it corresponds to the “area B2 facing the downward direction of the heat storage tank 90”.

On the other hand, one end of the second inlet part 440 may be openly formed in the form of opening 443. In this case, a portion of the first fluid flowing inside the second water inlet pipe 430 is discharged via the through holes 441 in the downward direction of the second inlet part 440 to enter the heat storage tank 90, and the remainder is discharged through the opening 443 in the left direction of the second inlet part 440 (relative to FIG. 3) to enter the heat storage tank 90.

The second water outlet pipe 450 is a configuration that guides the first fluid introduced into the heat storage tank 90 through the second water inlet pipe 430 to the first heat exchanger side. The second water outlet pipe 450 may be configured as a pipe connected to the inside of the heat storage tank 90.

The second water outlet pipe 450 includes a second inlet 453 that is formed in communication with the inside of the heat storage tank 90 so that the first fluid stored in the heat storage tank 90 can be introduced into the second water outlet pipe 450.

The second inlet 453 is formed to be in a region lower than the area where the second inlet part 440 of the second water inlet pipe 430 is in the heat storage tank 90.

According to a preferred embodiment, in particular, the first inlet part 410 of the first water inlet pipe 400 may be configured to be located in an area higher than the area in which the second inlet part 440 of the second water inlet pipe 430 is located in the heat storage tank 90.

The vortex preventing plate 460 may include a plate disposed in an area that is further down than the area in which the first inlet part 410 is located, and higher than the area in which the second inlet part 440 is located.

In this case, the vortex preventing plate 460 may be disposed in a structure lying inside the heat storage tank 90. For example, the vortex preventing plate 460 may be disposed in a structure in which the long axis is orthogonal in the height direction of the heat storage tank 90.

According to a preferred embodiment, the vortex preventing plate 460 may be composed of a plate consisting of a diameter 3 to 5 times the size of the inner diameter of the first water inlet pipe 400 or the second water inlet pipe 430.

According to the vortex preventing apparatus as described above, the water pressure of the first fluid entering the heat storage tank 90 can be effectively dispersed and diffused to prevent vortex generation, and heat loss can be minimized, which in turn can improve the heat exchange efficiency, provide cooling/heating at constant temperature, and promote the stable operation of the system.

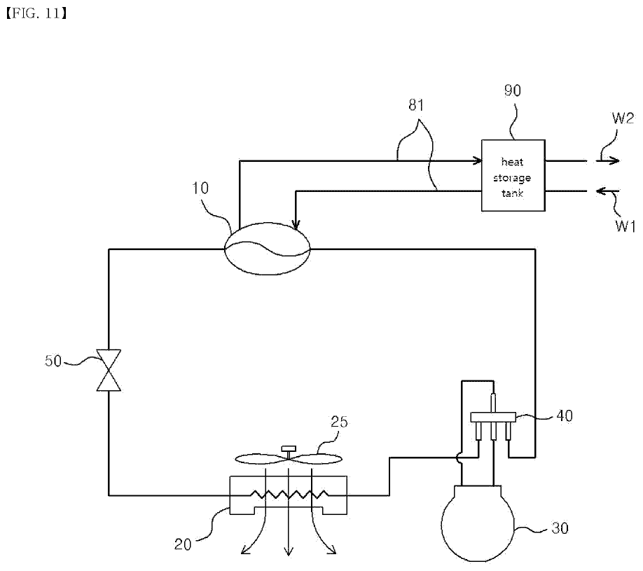

FIG. 9 is a block diagram of a heat pump system according to the second embodiment of the present invention. Referring to FIG. 9, the heat pump system according to the second embodiment is basically composed of the same configuration as the heat pump system of the first embodiment, but the difference is that it does not include the second heat exchanger of the first embodiment. Hereinafter, the difference between not including the second heat exchanger will be described.

In the first embodiment, the first fluid of cold water or hot water stored in the heat storage tank 90 is heat exchanged with the second fluid through the second heat exchanger 200 via the second fluid line 93, and then returned to the heat storage tank 90. The first fluid of cold or hot water means that the first fluid may be hot water or cold water according to the heating mode or the cooling mode, respectively.

Since the heat pump system according to the second embodiment does not include a second heat exchanger, the first fluid of cold or hot water stored in the heat storage tank 90 is supplied directly to the load and used for heat exchange on the load side, and then return to the heat storage tank 90.

That is, the first fluid of the cold/hot water of the first embodiment does not flow directly into the load, while the first fluid of the cold/hot water of the second embodiment flows to the load and is directly used for cooling/heating on the load.

The meaning of cold/hot water is that a cold water in a cooling mode and a hot water in a heating mode.

Here, the term ‘load’ means a user device such as an air conditioner, heater, heating distribution, hot water heater, and the like.

Meanwhile, according to a second embodiment of FIG. 9, the same vortex preventing apparatus as described in the first embodiment may be provided, in which case there are the following differences compared to the vortex preventing apparatus described in the first embodiment.

According to the second embodiment of FIG. 9, the first water outlet pipe 420 of the vortex preventing apparatus guides the first fluid introduced into the heat storage tank 90 through the first water inlet pipe 400 to drain to the load (i.e., the user device).

According to the second embodiment of FIG. 9, the second water inlet pipe 430 of the vortex preventing apparatus guides the introduction of the first fluid returning after being used (heat exchange, etc.) on the load (i.e., user device) into the heat storage tank 90.

In FIG. 9, ‘W1’ means a first fluid that is used for heat exchange on the user device and then re-introduced into the heat storage tank 90, and ‘W2’ means the first fluid, cold water or hot water, discharged from the heat storage tank 90 and flowing to the hot and cold water supply header 310 to be described below.

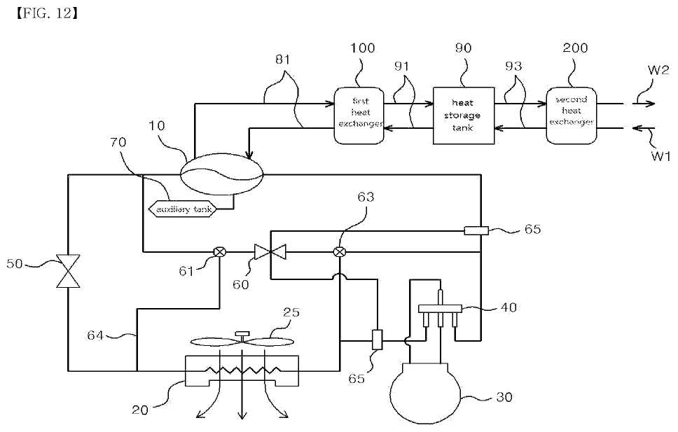

FIG. 10 is a configuration of the heat pump system according to the third embodiment of the present invention. Referring to FIG. 10, the heat pump system according to a third embodiment is composed of the same configuration as the heat pump system of the first embodiment, but the difference is that it does not include the first heat exchanger of the first embodiment.

In the first embodiment, the first fluid contained in the heat storage tank 90 is first exchanged with the thermal medium through the first heat exchanger 100 via the first fluid line 91, and then returned to the heat storage tank 90.

The heat pump system according to the 3rd embodiment does not include a first heat exchanger, and the difference is that the heat storage tank 90 inflows/outflows a thermal medium instead of the first fluid of the first embodiment.

Specifically, the thermal medium of the third embodiment is output from the heat storage tank 90 input to the indoor unit 10 via the heating medium line 81. The thermal medium becomes cold or hot water through the indoor unit 10 and then flows back into the heat storage tank 90.

The thermal medium of the cold or hot water introduced into the heat storage tank 90 is discharged to the second heat exchanger, and the thermal medium passes through the second heat exchanger 200 via the second fluid line 93 for heat exchanging and after heat exchange is made, it is returned to the heat storage tank 90.

meanwhile, according to the third embodiment of FIG. 10, the same vortex preventing apparatus as described in the first embodiment may be provided, in which case there are the following differences compared to the vortex preventing apparatus described in the first embodiment.

That is, according to the third embodiment, the difference is that the first water inlet pipe 400 of the vortex preventing apparatus guides the thermal medium returning after passing through the indoor unit 10 to enter the heat storage tank 90.

In FIG. 10, ‘W1’ means a second fluid that is used for heat exchange at a load (i.e., user device) and then introduced back into the second heat exchanger 200, and ‘W2’ means a second fluid that is heat exchanged with the thermal medium in the second heat exchanger 200 and flows to the hot and cold water supply header 310 to be described below.

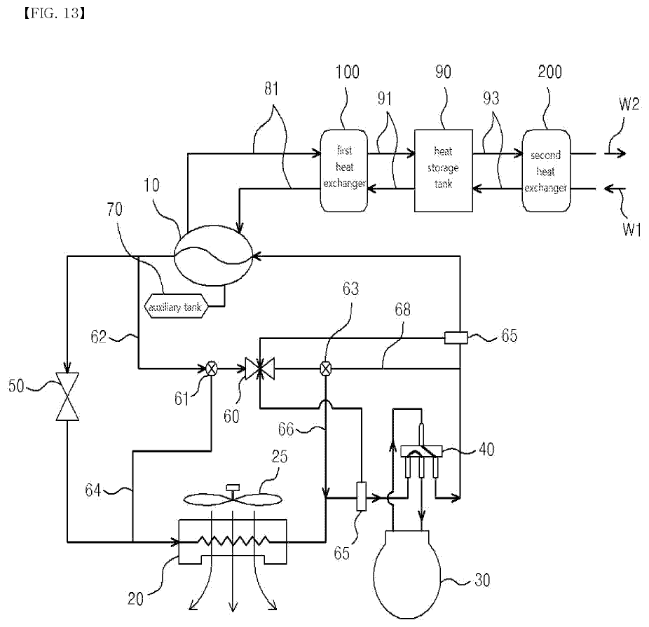

FIG. 11 is the configuration of the heat pump system according to the 4th embodiment of the present invention. the heat pump system according to 4TH embodiment is basically configured in the same configuration as the heat pump system of the first embodiment, except that it does not include the first heat exchanger and the second heat exchanger of the first embodiment. Hereinafter, the differences due to not including the 1st and 2nd heat exchangers will be described in a manner.

In the case of first embodiment, the first fluid contained in the heat storage tank 90 is first exchanged with the thermal medium through the first heat exchanger 100 via the first fluid line 91, and then returned to the heat storage tank 90.

The heat pump system according to the 4th embodiment does not include a first heat exchanger, and the difference is that the heat storage tank 90 input/output a thermal medium instead of the first fluid of the first embodiment.

Specifically, the thermal medium of the fourth embodiment is output from the heat storage tank 90 and then input to the indoor unit 10 via the heating medium line 81. The thermal medium becomes cold or hot water through the indoor unit 10 and then flows back into the heat storage tank 90.

And, in the case of the first embodiment, the first fluid, cold or hot water, stored in the heat storage tank 90 is heat exchanged with the second fluid at a second heat exchanger 200 via the second fluid line 93 and then returned to the heat storage tank 90 after the heat exchange is made.

Since the heat pump system according to embodiment 4 does not include a second heat exchanger, the thermal medium, cold water or hot water, stored in the heat storage tank 90 is supplied directly to the load and used for heat exchange on the load, and then back to the heat storage tank 90.

Since the heat pump system according to embodiment 4 does not include a second heat exchanger, the thermal medium, cold water or hot water, stored in the heat storage tank 90 is supplied directly to the load and used for heat exchange on the load, and then back to the heat storage tank 90.

That is, the first fluid, cold or hot water, of the first embodiment does not flow directly into the load, while the thermal medium, cold or hot water of the 4th embodiment flows to the load and is used directly for cooling/heating on the load side.

In FIG. 11, ‘W1’ means a thermal medium that is used for heat exchange on the user device and then reintroduced into the heat storage tank 90, and ‘W2’ means a thermal medium of cold and hot water discharged from the heat storage tank 90 and flowing to the hot and cold water supply header 310 to be described below.

In FIG. 12 is the configuration of the heat pump system according to an embodiment of the present invention. Referring to FIG. 12, an embodiment of the present invention of FIG. 12, it is the same as the heat pump system described in the first embodiment of FIG. 1, except that it further includes a liquid heater 60 and a sensor 65.

The liquid heater 60 functions by outputting a portion of the liquid refrigerant from the outlet of the condenser and mixing it into a dry saturated vapor inputting the compressor 30.

Specifically, the liquid heater 60 draws a small amount of refrigerant from the outlet of the condenser and inputs it into the inlet of the compressor 30, thereby increasing the low temperature/low-pressure dry saturated steam inputting the compressor 30.

According to one embodiment, the liquid heater 60 evaporates the refrigerant delivered at the outlet of the condenser and mixes it into the dry saturated steam inputting the compressor 30.

The liquid heater 60 may be formed in a valve structure that can adjust the amount of refrigerant outputting from the outlet of the condenser as needed.

Whether the valve of the liquid heater 60 is opened or closed and the degree of opening and closing (i.e., refrigerant withdrawal amount) is adjusted according to the temperature of the refrigerant detected by the sensor 65 mounted on the outlet side of the compressor 30.

According to one embodiment, the liquid heater 60 evaporates the refrigerant delivered at the outlet of the condenser and mixes it into the dry saturated steam inputting the compressor 30.

The liquid heater 60 may be formed in a valve structure that can adjust the amount of refrigerant outputting from the outlet of the condenser as needed.

Whether the valve of the liquid heater 60 is opened or closed and the degree of opening and closing (i.e., refrigerant withdrawal amount) is adjusted according to the temperature of the refrigerant detected by the sensor 65 mounted on the outlet side of the compressor 30.

When such a liquid heater 60 is further provided, a temperature of the refrigerant entering the compressor 30 can be appropriately adjusted. Accordingly, the load on the compressor 30 can be reduced to improve the stability and efficiency of the heat pump system.

The heat pump system of the present invention may further include an auxiliary tank 70. In this case, the auxiliary tank 70 may be connected to the indoor unit 10 to transfer the heating or cooling heat generated from the indoor unit 10 and store it in the form of hot or cold water.

Meanwhile, an embodiment of FIG. 12, although described with reference to the heat pump system according to the first embodiment of 1, it is natural that such liquid heater 60 and sensor 65 may also be applied to the heat pump system according to the 2nd embodiment, the 3rd embodiment, and the 4th embodiment.

Below, based on the heat pump system according to the first embodiment of FIG. 1, a heat exchange operation in the cooling or heating mode of the heat pump system is described.

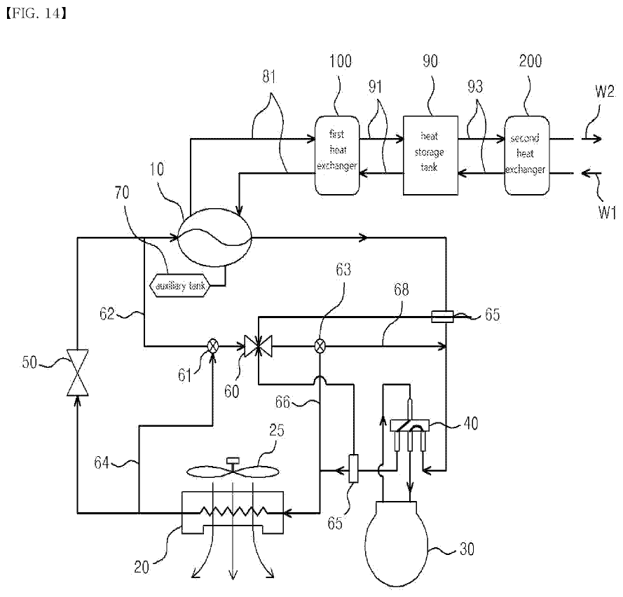

FIG. 13 is a view showing the flow of a refrigerant, a thermal medium, a first fluid and a second fluid and a heat exchange operation thereof when the heat pump system according to the present invention operates for heating.

Referring to FIG. 13, when the heat pump system of the present invention is operated for heating, the indoor unit 10 acts as a condenser and the outdoor unit 20 acts as an evaporator.

The compressor 30 compresses the dry saturated refrigerant delivered from the evaporator and converts it into an overheated steam state.

The superheated vapor that passes through the compressor 30 is converted into a liquid phase in the indoor unit 10 (i.e., the condenser) and dissipates latent heat. That is, the refrigerant of the indoor unit 10 dissipates heat during the condensing process and is heat exchanged with the thermal medium via the indoor unit 10 so that it can be heat stored.

Specifically, the heat dissipated during the condensation process is transferred to a thermal medium via the indoor unit 10, which is heat exchanged with the first fluid as it passes through the first heat exchanger 100, which eventually fills the heat storage tank 90 with a high temperature first fluid.

In addition, the first fluid of high temperature stored in the heat storage tank 90 is heat exchanged with the second fluid by a second heat exchanger 200 via the second fluid line 93, and the heat transferred-second fluid is supplied to the user device for the intended use, for example, an air conditioner, a heater, etc.

The refrigerant that has passed through the indoor unit 10 (i.e., the condenser) is introduced into the expansion valve 50 and converted into a wet steam.

The refrigerant in the wet vapor state via the expansion valve 50 is introduced into the outdoor unit 20 (i.e., the evaporator). The wet vapor introduced into the outdoor unit 20 instantaneously plummets to −20˜−30° C., exchanges heat with the outside, and the temperature rises. without considering the instantaneous temperature drops only looking at an external part, the humid steam of the low temperature pressure of approximately 15° C., which is introduced into the evaporator by the wind by the fan, is converted into a dry saturated steam of low temperature and low pressure of 0 to 5° C. while passing through the evaporator.

In addition, the low temperature and low pressure dry saturated steam via the outdoor unit 20 (i.e., the evaporator) is introduced into the compressor 30 through the four-way valve 40 and compressed. The refrigerant via the compressor 30 then enters the condenser again via the four-way valve 40 to form a new heating cycle.

On the other hand, before the low temperature and low pressure dry saturated steam via the outdoor unit 20 (i.e., the evaporator) is introduced into the compressor 30, a small amount of liquid refrigerant may be mixed by the liquid heater 60.

That is, the liquid heater 60 outputs a portion of the liquid refrigerant from the outlet side of the indoor unit 10 (i.e., the condenser) and mixes it in a dry saturated vapor introduced into the compressor 30.

The liquid heater 60 outputs a small amount of refrigerant from the outlet of the indoor unit 10 and inputs to the inlet of the compressor 30, thereby increasing the temperature of the low temperature/low pressure dry saturated steam inputting the compressor 30.

When the temperature of the outside air drops below zero or below 5° C., the temperature of the dry saturated steam at low temperature and low pressure via the outdoor unit 20 (i.e., the evaporator) becomes lower than 0-5° C., and when a refrigerant with a low temperature inputs the compressor 30, the temperature on the outlet of the compressor 30 is low, so that the temperature of the hot water in the indoor unit 10 (i.e., the condenser) cannot be properly increased. Thus, by outputting a small amount of refrigerant from the outlet side of the indoor unit 10 (i.e., the condenser) and inputting it into the inlet of the compressor 30, it may be configured to increase the temperature of the low-temperature low-pressure dry saturated steam inputting the compressor 30.

The inventors of the present invention have developed the following conditions in the heating operation of the heat pump system as described above, in particular that the heat exchange of 13 to 18° C. can be implemented at optimum efficiency when heating and can supply heating at a constant temperature. Here, the term ‘constant temperature’ means a heating temperature of 13 to 18° C.

The refrigerant of the heat pump system of the present invention may use R407C.

In addition, the thermal medium of the heat pump system of the present invention may use antifreeze. In this case, the antifreeze may be used in dilution with water. Preferably, the ratio of water diluted in the antifreeze may be 20 to 25% by volume compared to the total solution.

In an environment using the above refrigerants and antifreezes, the heat pump system of the present invention should be designed to satisfy at least the following the first and the second conditions, preferably to be designed to further satisfy 3rd to fifth condition.

1^{st} Condition for the Heat Exchanger

The first heat exchanger 100 is composed of a plate heat exchanger. In the above case, as described and shown in FIGS. 2 and 3, the first heat exchanger 100 may be comprised of a plate heat exchanger.

In a condition where the inner diameter of the first pipe of the first heat exchanger 100 is 3 mm, the first heat exchanger 100 may be configured to meet the following conditions:

That is, the first channel 140 of the first heat exchanger 100 is configured such that the antifreeze flows at an average flow rate of 0.8 to 1.2 m/s within the first channel 140, preferably at an average flow rate of 0.9 to 1.1 m/s.

Preferably, under conditions where the inner diameter of the second pipe of the first heat exchanger 100 is 5 mm, the first heat exchanger 100 may be configured to further satisfy the following conditions:

That is, the second channel 150 of the first heat exchanger 100 is composed of the first fluid flowing at an average flow rate of 2.8 to 3.2 m/s within the second channel 150, preferably at an average flow rate of 2.9 to 3.1 m/s.

2^{nd} Heat Exchanger

The second heat exchanger 200 is composed of a plate heat exchanger. In the above case, the second heat exchanger 200 may be composed of a plate heat exchanger as shown in FIGS. 4-5.

In a condition where the inner diameter of the third pipe of the second heat exchanger 200 is 5 mm, the second heat exchanger 200 must be configured to meet the following conditions:

That is, the third channel 240 of the second heat exchanger 200 is composed of the first fluid flowing at an average flow rate of 2.8 to 3.2 m/s within the third channel 240, preferably at an average flow rate of 2.9 to 3.1 m/s.

Overheated Steam Condition

The compressor 30 of the present invention compresses the refrigerant delivered from the evaporator and turns it into overheated steam. The compressor 30 is configured so that the ratio of overheated steam to the total refrigerant gas is 68-82%.

Compressor Driving Condition

The conventional heat pump had a low pressure of 6-7 kg f/cm² and a high pressure of 15 kg f/cm² when compressed, and the compression temperature of the refrigerant was designed based on 54.5° C. As a result, conventional heat pumps had little control over changes in the external air temperature, so the flow of refrigerant could not be kept constant continuously.

This is, since increasing the pressure of the compressor 30 without adjusting the temperature of the refrigerant according to the change in the outside temperature causes a sudden load on the heat pump system and the system cannot withstand it, As described above, 15 kg f/cm² is set as the critical pressure.

The heat pump system of the present invention can directly adjust the temperature of the refrigerant gas entering the compressor 30 through the liquid heater 60, so that the pressure of the compressor 30 can be raised above the critical pressure of the existing heat pump system.

In such an environment, the compressor 30 of the present invention is configured to meet the following conditions: That is, the compressor 30 is configured so that the high pressure at the time of compression is 26 kg f/cm², and the temperature of the refrigerant discharged from the compressor 30 is 128 to 132° C. (Preferably 129 to 131° C.).

Heat Transfer Conditions

The heat pump system of the present invention is configured so that, in the process of heating heat being transferred to the indoor unit 10 (condenser)→the first heat exchanger 100→the heat storage tank 90→the second heat exchanger 200, the temperature drops by 1° C. during the heating operation.

On the other hand, the heat pump system of the present invention is configured to increase the temperature by 1° C. in the process of transferring the heat to the indoor unit 10 (evaporator)→the first heat exchanger 100→the heat storage tank 90→the second heat exchanger 200 during the cooling operation.

For example, if the cooling heat in the indoor unit 10 is 2° C., the cooling heat exchanged in the first heat exchanger 100 is 3° C., the cooling heat stored in the heat storage tank 90 is 4° C., and the heat exchanged cooling heat in the second heat exchanger 200 is configured to be 5° C.

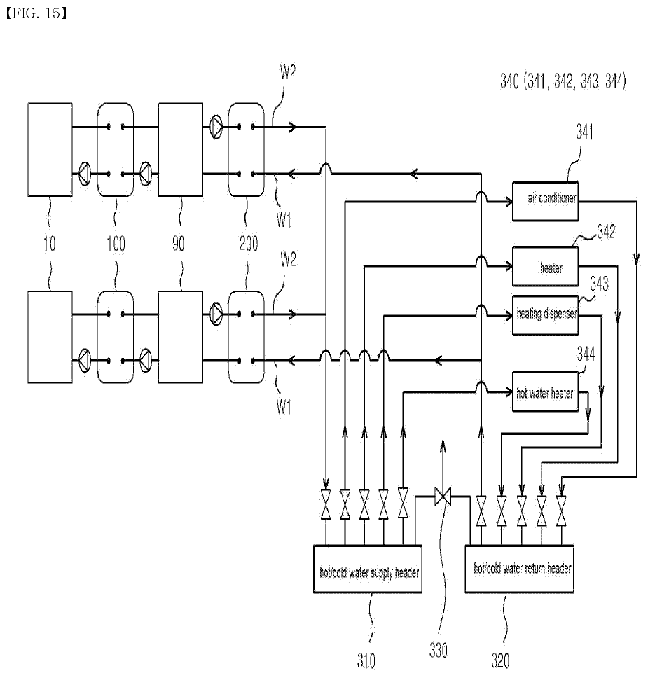

FIG. 14 is a diagram showing the flow of the refrigerant, the thermal medium, the first fluid and the second fluid and the heat exchange operation thereof when the heat pump system operates for cooling according to aspect of the present invention.

Referring to FIG. 14, when the heat pump system of the present invention is operated for cooling, there are the following differences, including the direction in which the refrigerant flows compared to when operating for heating.

When the heat pump system of the present invention is operated for cooling, the indoor unit 10 acts as an evaporator and the outdoor unit 20 acts as a condenser.

In addition, in the cooling operation of the heat pump system, the circulation cycle of the refrigerant is briefly described as follows.

The high-pressure refrigerant compressed in the compressor 30 enters the outdoor unit 20 (i.e., the condenser). The outdoor unit 20 condenses the refrigerant delivered from the compressor 30. The refrigerant is then introduced into the indoor unit 10 (i.e., the evaporator) after the expansion valve 50 to heat exchange with the antifreeze. That is, the refrigerant absorbs and evaporates the thermal energy of the antifreeze in the indoor unit 10 (i.e., the evaporator), thereby enabling cold storage by heat exchange with the antifreeze via the outdoor unit 20 (i.e., the condenser).

Specifically, the low-temperature antifreeze deprived of heat in the condensation process of the refrigerant is heat exchanged with the first fluid as it passes through the first heat exchanger 100, so that the heat storage tank 90 is eventually filled with the first fluid at low temperature, i.e., cold water. In addition, the first fluid of low temperature stored in the heat storage tank 90 is heat exchanged with the second fluid by means of a second heat exchanger 200 via the second fluid line 93, whereby the second fluid becomes low temperature is supplied and used to a desired usage.

The evaporated refrigerant re-enters the compressor 30 again to form a cooling cycle.

The four-way valve 40 alters the path through which the refrigerant flows, so that the indoor unit 10 can act as an evaporator and the outdoor unit 20 can act as a condenser.

Before the low temperature and low pressure dry saturated steam via the indoor unit 10 (i.e., the evaporator) is introduced into the compressor 30, a small amount of liquid refrigerant may be mixed by the liquid heater 60.

On the other hand, in the heating operation, the liquid heater 60 is configured to output a small amount of refrigerant from the outlet side of the indoor unit 10 (i.e., the condenser) through the first refrigerant input output line 62 and input it into the inlet side of the compressor 30 through the first refrigerant input line 66.

On the other hand, in the cooling operation, the liquid heater 60 is configured to output a small amount of refrigerant from the outlet side of the outdoor unit 20 (i.e., the condenser) through the second refrigerant input output line 64 and input it into the inlet side of the compressor 30 through the second refrigerant input line 68.

As such, the first refrigerant input output line 62 and the second refrigerant input output line 64 are optionally used according to the cooling/heating operation, and the first refrigerant input line 66 and the second refrigerant input line 68 are also optionally used.

Thus, in accordance with the cooling/heating operation, a first switching valve 61 may be installed between the first refrigerant input output line 62 and the second refrigerant input output line 64 for the switching between the first refrigerant input output line 62 and the second refrigerant input output line 64.

And, in accordance with the cooling/heating operation, a second switching valve 63 may be installed between the first refrigerant input line 66 and the second refrigerant input line 68 for the transition between the first refrigerant input line 66 and the second refrigerant input line 68.

The inventors herein have developed the following conditions in the cooling operation of the heat pump system as described above, that heat exchange of 3 to 7° C. can be implemented at optimum efficiency during cooling and can supply cooling at constant temperature. Here, the term ‘constant temperature’ refers to the cooling temperature of 3 to 7° C.

For this purpose, the refrigerant of the heat pump system of the present invention may use R407C.

In addition, the thermal medium of the heat pump system of the present invention may use an antifreeze. In this case, the antifreeze may be used in dilution with water. Preferably, the ratio of water diluted to the antifreeze may be 20 to 25% by volume compared to the total solution.

In an environment using the above refrigerants and antifreezes, the heat pump system of the present invention may be designed to at least satisfy conditions 1 and 2 described above, preferably to be designed to more satisfy conditions 3 to 5. Since the conditions described in the heating operation section of the heat pump system of FIG. 13 are the same, a detailed description will be omitted.

FIG. 15 is a block diagram of a cooling/heating system using the heat pump system of the present invention.

Referring to FIG. 15, The cooling/heating system of FIG. 15 has been described and illustrated with reference to the hip pump system according to the first embodiment, as well as such a cooling/heating system can also be applied to the heat pump system according to the second embodiment, the third embodiment and the 4th embodiment.

Referring to FIG. 15, the cooling/heating system of the present invention may include a heat pump system, a hot and cold water supply header 310, a hot and cold water return header 320, and a differential pressure valve 330.

The first fluid of high temperature stored in the heat storage tank 90 is heat exchanged with the second fluid by means of a second heat exchanger 200 via the second fluid line 93, and the heat transferred the second fluid can be used for a desired usage.

In FIG. 12, ‘W1’ means a second fluid flowing into the second heat exchanger 200, and ‘W2’ means a second fluid that is heat exchanged with the first fluid in the second heat exchanger 200 and flows to the cold and hot water supply header 310.

In FIG. 15, ‘W1’ means a fluid that is used for heat exchange at a load (i.e., a user device) and then enters the heat pump system again, and ‘W2’ means a fluid flowing to the side of the cold and hot water supply header 310 to be described below by a fluid that has become cold water or hot water in the heat pump system.

Here, the ‘desired usage’ may be a user device 340, such as an air conditioner 341, a heater 342, a heating dispenser 343, a hot water heater 344, and the like.

According to the first embodiment of FIG. 1 and the third embodiment of FIG. 10, the hot and cold water supply header 310 is configured to supply a second fluid of heat exchanged-cold second fluid in the second heat exchanger 200 of the heat pump system to the user device 340.

According to the second embodiment of FIG. 9, the hot and cold water supply header 310 is configured to supply a cold first fluid, i.e., a heat exchanged-cold first fluid, outputted from the heat storage tank of the heat pump system to the user device 340.

According to the fourth embodiment of FIG. 11, the hot and cold water supply header 310 is configured to supply a cold thermal medium outputted from the heat storage tank of the heat pump system to the user device 340.

The hot and cold water return header 320 is a device for recovering the second fluid used in the user device 340 (the first fluid in the second embodiment, the thermal medium in the fourth embodiment) and returning it to the second heat exchanger 200.

The second fluid (the first fluid in the case of the second embodiment, the thermal medium in the case of the 4th embodiment) returned to the heat pump system by the cold and hot water return header 320 is heat exchanged in the heat pump system with cold or hot water and supplied back to the user device 340.

A differential pressure valve 330 is installed between the hot and cold water supply header 310 and the hot and cold water return header 320 to regulate the pressure when a pressure of either the hot and cold water supply header 310 and the hot and cold return header 320 rises sharply.

Although a preferred embodiment of the present invention has been described and illustrated using certain terms above, such terms are only intended to clearly describe the present invention, and it is apparent that embodiments of the present invention and the terms described may be subject to various changes and changes without deviating from the technical spirit and scope of the following claims. Such modified embodiments should not be understood separately from the spirit and scope of the present invention and should be said to fall within the claims of the present invention.

1. A heat pump system, the system comprising:
an indoor unit configured to function as a condenser in heating and as an evaporator when cooling;
an outdoor unit that configured to function as an evaporator in heating and as a condenser in cooling;
a thermal medium configured to heat exchange through the indoor unit;
a heat storage tank configured to receive the thermal medium, which become cold water or hot water through the indoor unit;
a first water inlet pipe configured to guide the thermal medium returning after passing through the indoor unit into the heat storage tank
a first water outlet pipe configured to guide the thermal medium introduced into the heat storage tank through the first water inlet pipe to output from the heat storage tank;
a second water inlet pipe configured to guide the thermal medium introduced into the heat storage tank after outputting the heat storage tank through the first water outlet pipe;
a second water outlet pipe configured to guide the thermal medium introduced into the heat storage tank through the second water inlet pipe to be output the indoor unit;
wherein the first water inlet pipe comprises a first inlet part formed by a structure drawn into the heat storage tank and a plurality of through holes formed a portion of the first inlet part facing an upper direction of the heat storage tank, wherein the first inlet is formed in a region upper than a region in which the first inlet part is located in the heat storage tank,
wherein the first water outlet pipe comprises a first inlet formed in communication with the inside of the heat storage tank so that the first fluid in the heat storage tank can be introduced into the first water outlet pipe,
wherein the second water inlet pipe comprises a second inlet part formed in a structure introduced into the heat storage tank and a plurality of through holes formed a portion of the second inlet part in the downward direction of the heat storage tank,
wherein the second water outlet pipe includes a second inlet formed in communication with the inside of the heat storage tank so that the first fluid in the heat storage tank can be introduced into the inside of the second water outlet pipe,
wherein the second inlet is formed to be in a region lower than a region in which the second inlet part is in the heat storage tank.

2. The heat pump system of claim 1, further comprising:
a second heat exchanger in which heat exchange is performed between the thermal medium outputted from the heat storage tank through the first water outlet pipe and the second fluid;
wherein the first water outlet pipe guides the thermal medium introduced into the heat storage tank through the first water inlet pipe to the second heat exchanger,
wherein the second water inlet pipe guides the thermal medium returning after passing through the second heat exchanger to the heat storage tank.

3. A heat pump system, the heat pump system comprising:
an indoor unit configured to function as a condenser in heating and as an evaporator in cooling;
an outdoor unit configured to function as an evaporator in heating and as a condenser in cooling;
a thermal medium, which is heat exchanged through the indoor unit;
a first heat exchanger in which heat exchange between the thermal medium and a first fluid is performed;
a heat storage tank configured to receive the first fluid, which becomes cold water or hot water through the first heat exchanger;
a first water inlet pipe configured to guide the first fluid returning after via the first heat exchanger to input the heat storage tank;
a first water outlet pipe configured to guide the first fluid introduced into the heat storage tank through the first water inlet pipe to be output from the heat storage tank;
a second water inlet pipe configured to guide the first fluid, which flows out of the heat storage tank through the first water outlet pipe and then returns to the heat storage tank; and
a second water outlet pipe configured to guide the first fluid introduced into the heat storage tank through the second water inlet pipe to output to the first heat exchanger,
wherein the first water inlet pipe comprises a first inlet part formed by a structure drawn into the heat storage tank and a plurality of through holes formed a portion of the first inlet part facing an upper direction of the heat storage tank,
wherein the first water outlet pipe comprises a first inlet formed in communication with the inside of the heat storage tank so that the first fluid in the heat storage tank can be introduced into the first water outlet pipe,
wherein the second water inlet pipe comprises a second inlet part formed in a structure introduced into the heat storage tank and a plurality of through holes formed a portion of the second inlet part in the downward direction of the heat storage tank,
wherein the second water outlet pipe includes a second inlet formed in communication with the inside of the heat storage tank so that the first fluid in the heat storage tank can be introduced into the inside of the second water outlet pipe,
wherein the second inlet is formed to be in a region lower than a region in which the second inlet part is in the heat storage tank.

4. The heat pump system of claim 3, the heat pump system further comprising:
a second heat exchanger in which heat exchange is performed between the first fluid and the second fluid outputted to the heat storage tank through the first water outlet pipe,
wherein the first water outlet pipe is configured to output the first fluid introduced into the heat storage tank via the first water inlet pipe, to the second heat exchanger,
and wherein the second water inlet pipe is configured to input the first fluid returning after passing through the second heat exchanger into the heat storage tank.

5. The heat pump system of claim 1, wherein the first inlet part is formed in a region upper than a region in which the second inlet part is in the heat storage tank.

6. The heat pump system of claim 1, further comprising:
a first opening formed at one end of the first inlet part; and
a second opening formed at one end of the second inlet part.

7. The heat pump system of claim 5, further comprising:
a vortex preventing plate installed inside the heat storage tank, wherein the vortex preventing plate is in a region lower than the region in which the first inlet part is located, and upper than the region in which the second inlet part is located.

8. The heat pump system of claim 2, wherein the second heat exchanger is a plate heat exchanger.

9. The heat pump system of claim 1, further comprising:
a compressor for compressing a refrigerant delivered from the evaporator;
an expansion valve that expands the refrigerant received from the condenser; and
a four-way valve for switching the refrigerant flow according to heating and cooling.

10. The heat pump system of claim 9, further comprises a liquid heater is configured to hat draws a portion of the refrigerant from an outlet of the condenser and mixes the portion of the refrigerant in a dry saturated vapor entering the compressor.

11. The heat pump system of claim 10, wherein the liquid heater adjusts the withdrawal amount of the refrigerant according to the temperature of the refrigerant detected in the sensor installed at the outlet of the compressor.

12. The heat pump system of claim 3, wherein the thermal medium comprises an antifreeze.

13. A cooling/heating system, wherein the cooling/heating system includes the heat pump system of claim 1;
a hot and cold water supply header configured to supply hot or hot water to the user device for heat exchange completed a cold water or a hot water in the heat pump system; and
a cold and hot water return header configured to recover the cold or hot water used in the user device and returning the cold water or the hot water to the heat pump system.

14. The cooling/heating system using a heat pump system of claim 13, further comprising:
a differential pressure valve installed between the cold and hot water supply header and the cold and hot water return header.

15. The heat pump system of claim 2,
wherein the first inlet part is formed in a region upper than a region in which the second inlet part is in the heat storage tank.

16. The heat pump system of claim 2,
further comprising:
a first opening formed at one end of the first inlet part; and
a second opening formed at one end of the second inlet part.

17. The heat pump system of claim 3,
further comprising:
a first opening formed at one end of the first inlet part; and
a second opening formed at one end of the second inlet part.

18. The heat pump system of claim 2, further comprising:
a compressor for compressing a refrigerant delivered from the evaporator;
an expansion valve that expands the refrigerant received from the condenser; and
a four-way valve for switching the refrigerant flow according to heating and cooling.

19. The heat pump system of claim 4, wherein the thermal medium comprises an antifreeze.

20. A cooling/heating system, wherein the cooling/heating system includes the heat pump system of claim 2;
a hot and cold water supply header configured to supply hot or hot water to the user device for heat exchange completed a cold water or a hot water in the heat pump system; and
a cold and hot water return header configured to recover the cold or hot water used in the user device and returning the cold water or the hot water to the heat pump system.
